(19) United States
(12) Patent Application Publication
(10) Pub. No.: US 2008/0294581 A1
(43) Pub. Date: Nov. 27, 2008

(54) Device Comprising a Sensor Arrangement and an Estimator

(75) Inventors: Teunis Jan Ikkink, Eindhoven (NL); Hans Marc Bert Boeve, Eindhoven (NL); Gerjan Van De Walle, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/913,590

(22) PCT Filed: Apr. 27, 2006
(86) PCT No.: PCT/IB06/51317

§ 371 Date: May 16, 2008

(30) Foreign Application Priority Data
May 4, 2005 (EP) 05103751.3

(51) Int. Cl. G06N 5/02

(52) U.S. Cl. 706/46

(57) ABSTRACT

Devices (1) comprising sensor arrangements (2) for providing first field information defining at least parts of first fields and for providing second field information defining first parts of second fields are provided with estimators (4) for estimating second parts of the second fields as functions of mixtures of the first and second field information, to become more reliable and user friendly. The fields may be earth gravitational fields and/or earth magnetic fields and/or further fields. The mixtures comprise dot products of the first and second fields and/or first products of first components of the first and second fields in first directions and/or second products of second components of the first and second fields in second directions. The second parts of the second field comprise third components of the second field in third directions. The estimators (4) can further estimate third components of the first field in third directions as further functions of the first field information.

The invention relates to a device comprising a sensor arrangement and an estimator, and also relates to an estimator, to a method, to a processor program product and to a data carrier.

Examples of such a device are personal computers, electronic compasses, wrist watches, navigation devices, mobile phones, personal digital assistants and other handheld devices. The sensor arrangement for example comprises a magnetometer or a geomagnetic force detector and/or an accelerometer or a tilt angle detector.

A prior art device is known from US 2004/0172838, which discloses a device with a sensor arrangement comprising a geomagnetic force detector and a tilt angle detector. The geomagnetic force detector provides geomagnetic force information defining a geomagnetic force and the tilt angle detector provides tilt angle information defining a tilt angle. The geomagnetic force detector detects a first axis component and a second axis component of the geomagnetic force, and a geomagnetic force calculator calculates a third axis component of the geomagnetic force based on the geomagnetic force information only.

The known device is disadvantageous, inter alia, owing to the fact that it provides information that is reliable to a relatively small extent and/or unreliable to a relatively large extent.

It is an object of the invention, inter alia, to provide a device that provides information that is reliable to a relatively large extent and/or unreliable to a relatively small extent.

Further objects of the invention are, inter alia, to provide an estimator, a method, a processor program product and a data carrier that provide information that is reliable to a relatively large extent and/or unreliable to a relatively small extent.

The device according to the invention comprises:
a sensor arrangement for providing first field information defining at least a part of a first field and for providing second field information defining a first part of a second field, and
an estimator for estimating a second part of the second field as a function of a mixture of the first and second field information.

By introducing the estimator, the device according to the invention provides information that is reliable to a relatively large extent and/or unreliable to a relatively small extent. Compared to the prior art calculator, which calculates the second part of the second field based on the second field information only, the estimator mixes the first and second information to estimate the second part of the second field in a more reliable way.

The device according to the invention is further advantageous, inter alia, in that its more reliable and/or less unreliable information increases the user friendliness of the device. The mixture of the first and second field information may for example correspond with one or more combinations of one or more parts of the first and second field information.

An embodiment of the device according to the invention is defined by the part of the first field comprising respective first and second components of the first field in respective first and second directions and the first part of the second field comprising respective first and second components of the second field in respective first and second directions and the second part of the second field comprising a third component of the second field in a third direction. The respective first and second components in respective first and second directions are for example respective first axis and second axis components such as for example x-axis and y-axis components. The third component in the third direction is for example a third axis component such as for example a z-axis component. Other mutually different first and second and third directions are not to be excluded.

An embodiment of the device according to the invention is defined by the mixture comprising a dot product of the first and second fields and/or a first product of the first components of the first and second fields and/or a second product of the second components of the first and second fields. The dot product of the first and second fields and/or the first product of the first components and/or the second product of the second components are advantageous options for mixing the first and second information, without excluding further options.

An embodiment of the device according to the invention is defined by the dot product being prior knowledge. The dot product is loaded into the device, for example from a database during a production of the device and having a value for example depending on an estimated location of a use of the device, or for example from a database via a network during a use of the device and having a value for example depending of a location of the use of the device, without excluding other loadings.

An embodiment of the device according to the invention is defined by the part of the first field further comprising a third component of the first field in the third direction, the mixture being related to
either a difference between the dot product and a sum of the first and second products, which difference is divided by the third component of the first field,
or a square root of a further difference between a magnitude squared of the second field and a sum of the first component squared and the second component squared of the second field, which square root has a sign related to a sign of the difference between the dot product and the sum of the first and second products, multiplied by a sign of the third component of the first field.

This embodiment is especially useful in case the first field information defines the entire 3-dimensional first field and in case the unknown third component of the second field in the third dimension is to be estimated.

An embodiment of the device according to the invention is defined by the magnitude of the second field being prior knowledge. The magnitude of the second field is loaded into the device, for example from a database during a production of the device and having a value for example depending on an estimated location of a use of the device, or for example from a database via a network during a use of the device and having a value for example depending of a location of the use of the device, without excluding other loadings.

An embodiment of the device according to the invention is defined by the estimator being configured for further estimating a third component of the first field in the third direction as a further function of the first field information, an estimated third component of the first field being related to a square root of a difference between a magnitude squared of the first field and a sum of the first component squared and the second component squared of the first field, the mixture being related to
either a further difference between the dot product and a sum of the first and second products, which further difference is divided by the estimated third component of the first field,
or a square root of a yet further difference between a magnitude squared of the second field and a sum of the first component squared and the second component squared of the second field, which square root has a sign related to a sign of the further difference between the dot product and the sum of the first and second products, multiplied by a sign of the estimated third component of the first field.

This embodiment is especially useful in case the first field information defines only a 2-dimensional part of the 3-dimensional first field and in case the unknown third components of the first and second field in the third dimension are to be estimated.

An embodiment of the device according to the invention is defined by the magnitude of the first field and/or the magnitude of the second field being prior knowledge. The magnitude of the first field and the magnitude of the second field are loaded into the device, for example from a database during a production of the device and having values for example depending on an estimated location of a use of the device, or for example from a database via a network during a use of the device and having values for example depending of a location of the use of the device, without excluding other loadings.

Embodiments of the estimator according to the invention and of the method according to the invention and of the processor program product according to the invention and of the data carrier according to the invention correspond with the embodiments of the device according to the invention.

The invention is based upon an insight, inter alia, that the prior art calculator calculates the second part of the second field based on the second field information only, and is based upon a basic idea, inter alia, that the estimator should mix the first and second information to estimate the second part of the second field in a more reliable way.

The invention solves the problem, inter alia, to provide a device that provides information that is reliable to a relatively large extent and/or unreliable to a relatively small extent, and is further advantageous, inter alia, in that its more reliable and/or less unreliable information increases the user friendliness of the device.

These and other aspects of the invention will be apparent from and elucidated with reference to the embodiments(s) described hereinafter.

In the drawings:

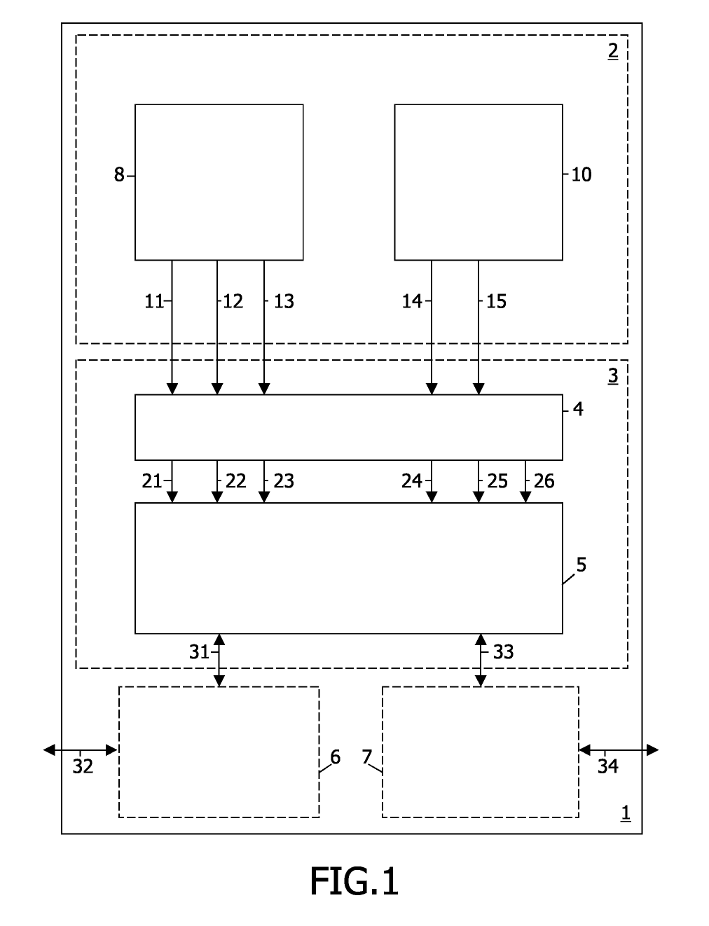

FIG. 1 shows diagrammatically a device according to the invention comprising an estimator according to the invention, and

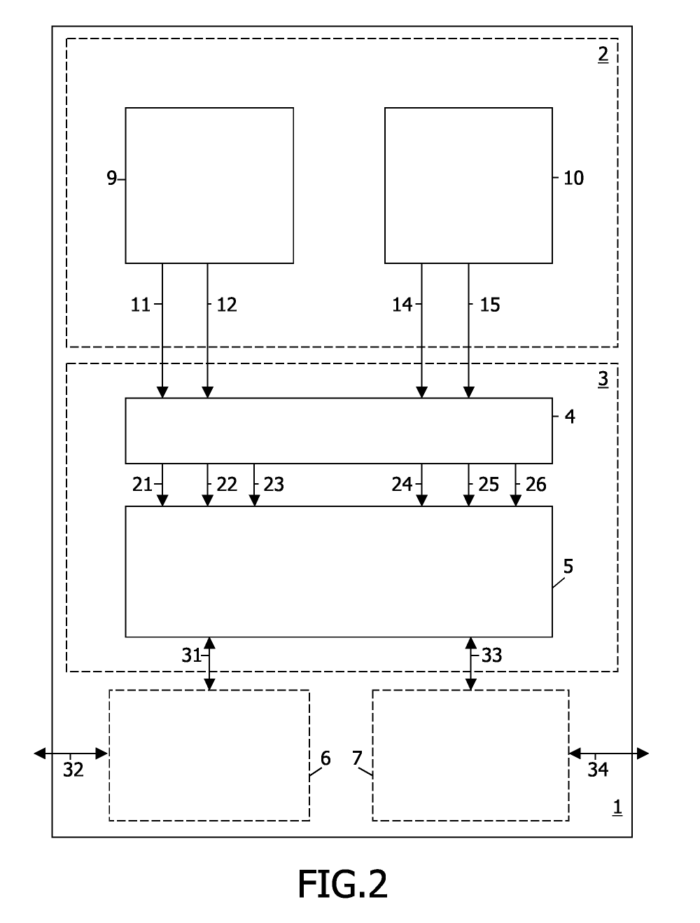

FIG. 2 shows diagrammatically a further device according to the invention comprising a further estimator according to the invention.

The device 1 according to the invention shown in FIG. 1 comprises a sensor arrangement 2 comprising a first sensor 8 for providing first field information defining a first (vector) field and comprising a second sensor 10 for providing second field information defining a first part of a second (vector) field. The device 1 further comprises a controller 3 comprising an estimator 4 according to the invention for estimating a second part of the second (vector) field and a processor 5. The estimator 4 is coupled via couplings 11-13 to the first sensor 8 and via couplings 14,15 to the second sensor 10 and is coupled via couplings 21-26 to the processor 5. The device 1 further comprises a man-machine-interface 6 or mmi 6 coupled to the processor 5 via a coupling 31. The mmi 6 either comprises a display, a keyboard, a loudspeaker and/or a microphone etc. or is to be coupled to a display, a keyboard, a loudspeaker and/or a microphone etc. via a coupling 32. The device 1 further comprises a network interface 7 coupled to the processor 5 via a coupling 33 and to be coupled wiredly or wirelessly to a network not shown here via a coupling 34.

The first sensor 8 provides the first field information defining the first field for example through respective first and second and third components of the first field Ux,Uy,Uz in respective first and second and third directions x,y,z. The second sensor 10 provides the second field information defining the first part of the second field for example through respective first and second components of the second field Vx,Vy in respective first and second directions x,y. The estimator 4 estimates the second part of the second field defined for example through a third component of the second field Vz in a third direction z.

According to the invention, the estimator 4 estimates the second part of the second field defined through Vz as a function of a mixture of the first and second field information defined through Ux,Uy,Uz,Vx,Vy. Thereto, the mixture for example comprises a dot product of the first and second fields and/or a first product of the first components of the first and second fields Ux,Vx and/or a second product of the second components of the first and second fields Uy,Vy.

This mixture may be related to for example a difference between the dot product and a sum of the first and second products, which difference is divided by the third component of the first field, in an equation:

Vz-estimated-1=(U·V−UxVx−UyVy)/Uz.

Alternatively, this mixture may be related to for example a square root of a further difference between a magnitude squared of the second field and a sum of the first component squared and the second component squared of the second field, which square root has a sign related to the difference between the dot product and the sum of the first and second products, which difference is divided by the third component of the first field, in an equation:

Vz-estimated-2=sign{(U·V−UxVx−UyVy)}sign{Uz}(|V|²−Vx²−Vy²)/^{1/2}.

In view of FIG. 1, the first sensor 8 supplies a signal Ux via the coupling 11, a signal Uy via the coupling 12 and a signal Uz via the coupling 13. The second sensor 10 supplies a signal Vx via the coupling 14 and a signal Vy via the coupling 15. The estimator 4 estimates Vz and supplies a signal Ux via the coupling 21, a signal Uy via the coupling 22, a signal Uz via the coupling 23, a signal Vx via the coupling 24, a signal Vy via the coupling 25 and a signal Vz-estimated-1 or 2 via the coupling 26.

In case Uz has a value close to zero, it would be better to use Vz-estimated-2, owing to the fact that it does not involve division by a value close to zero. Otherwise it would be better to use Vz-estimated-1 owing to the fact that Vz-estimated-1 might require the dot product U·V to be entered only. Vz-estimated-2 might require the dot product U·V as well as the magnitude |V| to be entered. So, preferably, the estimator 4 has both options available and comprises a detector not shown here for detecting for example the magnitude |Uz| and comprises a selector not shown here for in response to a detection selecting one of the two options. Alternatively, both options are used in parallel, and the estimator 4 comprises a comparator for comparing results of both options with each other and/or with stored data and comprises a selector for in response to a comparison selecting one of the two options. Further alternatively, both options are used in parallel, and the estimator 4 comprises a weighting unit for weighting the results of both options. Such a detector, such a selector, such a comparator and such a weighting unit may alternatively form part of the processor 5.

The dot product U·V and/or the magnitude |V| might be prior knowledge. This dot product and/or this magnitude might be loaded into the device 1, for example from a database during a production of the device 1 and having a value for example depending on an estimated location of a use of the device 1 (which estimated location might be close to the part of the world in which part of the world the device 1 is going to be sold). Alternatively the loading might be done for example from a database such as a website via a network such as an internet coupled wiredly or wirelessly to the device 1 via the coupling 34 during a use of the device 1 and having a value for example depending of a location of the use of the device 1 (which location of use might be close to a location of a first network unit of the network coupled wiredly or wirelessly to the device 1 via the coupling 34). Alternatively, a user might enter this dot product and/or this magnitude by hand in response to data supplied to the user directly or indirectly. The dot product and/or the magnitude may be stored in a memory of the controller 3 not shown here.

In view of the above, further equations show that there might be more equations available than unknown/estimated parameters:

|U|²=Ux²+Uy²+Uz²

|V|²=Vx²+Vy²+Vz-estimated²

U·V=UxVx +UyVy+UzVz-estimated

This redundancy can be used to improve the accuracy of the measured terms as provided by the sensor arrangement 2 and of the estimated term as provided by the estimator 4.

The device 1 according to the invention shown in FIG. 2 comprises a sensor arrangement 2 comprising a first sensor 9 for providing first field information defining only a part of a first (vector) field (not the entire first (vector) field as for FIG. 1) and comprising a second sensor 10 for providing second field information defining a first part of a second (vector) field. The device 1 further comprises a controller 3 comprising an estimator 4 according to the invention for estimating a second part of the second (vector) field and a processor 5. The estimator 4 is coupled via couplings 11,12 to the first sensor 9 and via couplings 14,15 to the second sensor 10 and is coupled via couplings 21-26 to the processor 5. The device 1 further comprises a man-machine-interface 6 or mmi 6 and a network interface 7 all already discussed for FIG. 1.

The first sensor 9 provides the first field information defining the part of the first field for example through respective first and second components of the first field Ux,Uy in respective first and second directions x,y. The second sensor 10 provides the second field information defining the first part of the second field for example through respective first and second components of the second field Vx,Vy in respective first and second directions x,y. The estimator 4 estimates the second part of the second field defined for example through a third component of the second field Vz in a third direction z.

Again according to the invention, the estimator 4 estimates the second part of the second field defined through Vz as a function of a mixture of the first and second field information defined through Ux,Uy,Vx,Vy. Thereto, the mixture for example comprises a dot product of the first and second fields and/or a first product of the first components of the first and second fields Ux,Vx and/or a second product of the second components of the first and second fields Uy,Vy. Further according to the invention, the estimator 4 further estimates a third component of the first field Uz in a third direction z as a further function of the first field information defined through Ux,Uy.

An estimated third component of the first field may be related to for example a square root of a difference between a magnitude squared of the first field and a sum of the first component squared and the second component squared of the first field, in an equation:

Uz-estimated=(|U|²−Vx²−Vy²)^{1/2}.

The mixture may be related to for example a difference between the dot product and a sum of the first and second products, which difference is divided by the third component of the first field, in an equation:

Vz-estimated-1=(U·V−UxVx−UyVy)/Uz-estimated.

Alternatively, this mixture may be related to for example a square root of a further difference between a magnitude squared of the second field and a sum of the first component squared and the second component squared of the second field, which square root has a sign related to a sign of the difference between the dot product and the sum of the first and second products, multiplied by a sign of the third component of the first field, in an equation:

Vz-estimated-2=sign{(U·V−UxVx−UyVy)}sign {Uz-estimated}(|V|²−Vx²−Vy²)^{1/2}.

In view of FIG. 2, the first sensor 9 supplies a signal Ux via the coupling 11 and a signal Uy via the coupling 12. The second sensor 10 supplies a signal Vx via the coupling 14 and a signal Vy via the coupling 15. The estimator 4 estimates Uz and Vz and supplies a signal Ux via the coupling 21, a signal Uy via the coupling 22, a signal Uz-estimated via the coupling 23, a signal Vx via the coupling 24, a signal Vy via the coupling 25 and a signal Vz-estimated-1 or 2 via the coupling 26.

In case Uz-estimated has a value close to zero, it would be better to use Vz-estimated-2, owing to the fact that it does not involve a division by a value close to zero. Otherwise it would be better to use Vz-estimated-1 owing to the fact that Vz-estimated-1 might require the dot product U·V to be entered only. Vz-estimated-2 might require the dot product U·V as well as the magnitude |V| to be entered. So, preferably, the estimator 4 has both options available and comprises a detector not shown here for detecting for example the magnitude |Uz-estimated| and comprises a selector not shown here for in response to a detection selecting one of the two options. Alternatively, both options are used in parallel, and the estimator 4 comprises a comparator for comparing results of both options with each other and/or with stored data and comprises a selector for in response to a comparison selecting one of the two options. Further alternatively, both options are used in parallel, and the estimator 4 comprises a weighting unit for weighting the results of both options. Such a detector, such a selector, such a comparator and such a weighting unit may alternatively form part of the processor 5.

The dot product U·V and/or the magnitude |U| and/or the magnitude |V| might be prior knowledge. This dot product and/or these magnitudes might be loaded into the device 1, for example from a database during a production of the device 1 and having a value for example depending on an estimated location of a use of the device 1 (which estimated location might be close to the part of the world in which part of the world the device 1 is going to be sold). Alternatively the loading might be done for example from a database such as a website via a network such as an internet coupled wiredly or wirelessly to the device 1 via the coupling 34 during a use of the device 1 and having a value for example depending of a location of the use of the device 1 (which location of use might be close to a location of a first network unit of the network coupled wiredly or wirelessly to the device 1 via the coupling 34). Alternatively, a user might enter this dot product and/or these magnitudes by hand in response to data supplied to the user directly or indirectly. The dot product and/or the magnitudes may be stored in a memory of the controller 3 not shown here.

In view of the above, further equations show that there might be more equations available than unknown/estimated parameters:

|U|²=Ux²+Uy²+Uz-estimated²

|V|²=Vx²+Vy²+Vz-estimated²

U·V=UxVx+UyVy+Uz-estimatedVz-estimated

This redundancy can be used to improve the accuracy of the measured terms as provided by the sensor arrangement 2 and of the estimated terms as provided by the estimator 4.

The first and second (vector) fields U and V might correspond with an earth gravitational field g and an earth magnetic field B or vice versa. Alternatively, one of the first and second (vector) fields U and V might correspond with either the earth gravitational field g or the earth magnetic field B and the other one might correspond with an other magnetic or electric or further field for example made by a human. Further alternatively, both the first and second (vector) fields U and V might each correspond with an other magnetic or electric or further field for example made by a human. The field information for the first and second fields is for example separately or combinedly used in the controller 5 and/or is for example separately or combinedly displayed via a display coupled to or forming part of the mmi 6.

The first sensor 8,9 and the second sensor 10 are for example biaxial sensors for each providing field information defining a part of a field through for example respective first and second components in respective first and second directions. Alternatively, one of the sensors 8-10 can be a triaxial sensor for providing field information defining an entire field through for example respective first and second and third components in respective first and second and third directions. Further alternatively, only one sensor might be used for providing field information about two (or more) fields. This is for example possible in case the fields are coded, multiplexed in time and/or multiplexed in frequency etc. Finally, a third sensor etc. and a third field etc. are not to be excluded. In that case, the invention will provide first and second and third etc. field information defining at least parts of first and second and third etc. fields and will estimate a part of one of the fields as a function of a mixture of the field information about this one field and field information about at least one of the other fields and/or will estimate a part of a further one of the fields as a function of a mixture of the field information about this further one field and field information about at least one of the yet other fields etc.

The fact that at least one of the sensors 8-10 does not need to be a triaxial sensor but can be a biaxial sensor is a great advantage, owing to the fact that biaxial sensors can be produced easier and at lower costs and can be more durable and of a smaller size. However, the invention is not limited to at least one of the sensors 8-10 being a biaxial sensor but can also be used for improving the performance of triaxial sensors.

Instead of using a first and second and third components of a field in first and second and third directions, field information about this field might be defined in a different way, for example by using a magnitude and two angles of this field (one angle with respect to one plane and one other angle with respect to one other plane) etc. Even then, the invention still estimates a part of the second field as a function of a mixture of the first and second field information.

The estimator 4 might be 100% hardware and comprise an estimating circuit, might be 100% software and comprise an estimating module, and might be a mix of both. Independently of its realization, the estimator 4 may form part of the processor 5, partly or entirely.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware or by the same module of software. The mere fact that certain measures are recited in mutually different dependent claims does not indicate that a combination of these measures cannot be used to advantage.

1. A device comprising:
a sensor arrangement for providing first field information defining at least a part of a first field and for providing second field information defining a first part of a second field, and
an estimator for estimating a second part of the second field as a function of a mixture of the first and second field information.

2. The device as defined in claim 1, the part of the first field comprising respective first and second components of the first field in respective first and second directions and the first part of the second field comprising respective first and second components of the second field in respective first and second directions and the second part of the second field comprising a third component of the second field in a third direction.

3. The device as defined in claim 2, the mixture comprising a dot product of the first and second fields and/or a first product of the first components of the first and second fields and/or a second product of the second components of the first and second fields.

4. The device as defined in claim 3, the dot product being prior knowledge.

5. The device as defined in claim 3, the part of the first field further comprising a third component of the first field in the third direction, the mixture being related to
either a difference between the dot product and a sum of the first and second products, which difference is divided by the third component of the first field,
or a square root of a further difference between a magnitude squared of the second field and a sum of the first component squared and the second component squared of the second field, which square root has a sign related to a sign of the difference between the dot product and the sum of the first and second products, multiplied by a sign of the third component of the first field.

6. The device as defined in claim 5, the magnitude of the second field being prior knowledge.

7. The device as defined in claim 3, the estimator being configured for further estimating a third component of the first field in the third direction as a further function of the first field information, an estimated third component of the first field being related to a square root of a difference between a magnitude squared of the first field and a sum of the first component squared and the second component squared of the first field, the mixture being related to
either a further difference between the dot product and a sum of the first and second products, which further difference is divided by the estimated third component of the first field,
or a square root of a yet further difference between a magnitude squared of the second field and a sum of the first component squared and the second component squared of the second field, which square root has a sign related to a sign of the further difference between the dot product and the sum of the first and second products, multiplied by a sign of the estimated third component of the first field.

8. The device as defined in claim 7, the magnitude of the first field and/or the magnitude of the second field being prior knowledge.

9. An estimator for estimating a part of a second field as a function of a mixture of first and second field information originating from a sensor arrangement, the first field information defining at least a part of a first field and the second field information defining a further part of the second field.

10. A method for estimating a part of a second field in response to first and second field information originating from a sensor arrangement, the first field information defining at least a part of a first field and the second field information defining a further part of the second field, the method comprising an estimation of the part of the second field as a function of a mixture of the first and the second field information.

11. A processor program product to be run via a processor for estimating a part of a second field in response to first and second field information originating from a sensor arrangement, the first field information defining at least a part of a first field and the second field information defining a further part of the second field, the processor program product comprising an estimation of the part of the second field as a function of a mixture of the first and the second field information.

12. A data carrier comprising the processor program product as defined in claim 11.
